(19) United States
(12) Patent Application Publication
(10) Pub. No.: US 2011/0272335 A1
(43) Pub. Date: Nov. 10, 2011

(54) IMMERSED MEMBRANE CASSETTE AND METHOD OF OPERATION

(76) Inventor: Pierre Lucien Cote, Dundas (CA)

(21) Appl. No.: 13/144,371

(22) PCT Filed: Jan. 14, 2010
(86) PCT No.: PCT/CA2010/000052

§ 371 Date: Jul. 13, 2011

Related U.S. Application Data
(60) Provisional application No. 61/144,723, filed on Jan. 14, 2009.
(60) Provisional application No. 61/249,844, filed on Oct. 8, 2009.
(60) Provisional application No. 61/249,847, filed on Oct. 8, 2009.
(60) Provisional application No. 61/249,853, filed on Oct. 8, 2009.

(51) Int. Cl. B01D 65/02; B01D 35/00

(52) U.S. Cl. 210/150; 210/198.1; 210/636

(57) ABSTRACT

A module of vertical membranes has a lower header with integral air holes. Modules are mounted in line on upper and lower beams. A skirt is formed under the cassette. Adjustable side members between the beams allow for membrane slack adjustment and bottom beam levelling. A flat aerator assembly can be inserted into spaces between the cassettes and provide bubbles into the skirts, the spaces between cassettes, or both. An aeration method involves producing bubbles primarily or only to one side of the module, alternating from one side of the module to the other, while also producing bubbles within the module or between the membranes, optionally continuously. A cleaning method involves flowing a chemical cleaning solution by force of gravity through a membrane module, optionally by injected a concentrated solution into a vented portion of a permeate withdrawal system located above the water level in a tank holding the module.

For the United States of America, this is an application claiming the benefit under 35 USC 119(e) of U.S. Application Ser. Nos. 61/144,723 filed Jan. 14, 2009; 61/249,844 filed on Oct. 8, 2009; 61/249,847 filed on Oct. 8, 2009; and, 61/249,853 filed on Oct. 8, 2009, all of which are incorporated herein in their entirety by this reference to them.

### FIELD

This specification relates to immersed membrane systems, for example suction driven immersed microfiltration or ultrafiltration systems for producing usable water or treating wastewater, and methods of membrane system operation including methods to inhibit fouling such as aeration (or gas bubble scrubbing) methods and chemical cleaning methods.

### BACKGROUND

Immersed membrane systems, for example membrane bioreactors, may use hollow fiber ultrafiltration or microfiltration membranes immersed in a tank of water (including wastewater) to be treated. Many hollow fibers may be mounted vertically between upper and lower potting heads to form a module. The module is typically kept to a size that can be handled by a person. In order to provide the membrane surface area necessary for large systems, modules are connected together into larger assemblies, sometimes called cassettes. The configuration of the cassette and the arrangement of pipes around the cassettes can affect the cost of the installation, the ability to pack membrane area into a tank, the flow of fluids in the tank and the operational efficiency of the system.

U.S. Pat. No. 5,639,373 describes a module of immersed membranes. In one example, the membranes are oriented vertically between solid upper and lower rectangular potting heads and tubular aerators are placed on the sides of the lower potting head. In another example, the lower potting head of a module has a skirt extending below the potting head and tubes extending through the potting material. Air provided through a port in the side of the skirt flows though the tubes to create bubbles at the top of the lower potting head.

U.S. Pat. No. 6,245,239 describes a cyclic aeration system for submerged membrane modules. In one example, a set of rectangular modules with membranes oriented vertically between solid upper and lower potting heads has a set of aerators below the modules. A flow of air to the aerators is switched on and off in repeated cycles.

Maintenance cleaning is used to sustain the operation of immersed membranes, for example ultrafiltration or microfiltration membranes in a membrane bioreactor. In an example described in U.S. Pat. No. 6,547,968, maintenance cleaning involves frequent, for example 1-7 times per week, contact periods with cleaning chemical(s) to “condition” the fouling layer rather than attempt to remove it. The active chemical in the cleaning solution is often chlorine, but other oxidants, bases or acids can also be used. The efficiency of maintenance cleaning is related to the chlorine concentration and contact time. When NaOCl is used to supply chlorine, the concentration may be between 100-500 mg/L. The contact time may be several minutes to one hour.

### INTRODUCTION

The following introduction is intended to introduce the reader to the detailed discussion and not to limit or define any claimed invention. An invention may reside in a combination or subcombination of apparatus elements or process steps described in any part of this document including the Figures.

A module of vertically oriented membranes has an upper permeating header and a lower dead end header with integral air holes. The headers are not fixed apart from each other in the module itself. The module preferably has a square cross section in plan view, but with a permeate cap that provides a round permeate connection. The modules are mounted in line on upper and lower beams to form a cassette. The cassette is an elongated rectangular shape in plan view. A skirt is formed under the modules or cassette to provide an open bottomed chamber under the lower headers in communication with the air holes. Adjustable side members between the beams allow for membrane slack adjustment and bottom beam levelling. A permeate header is provided above and in line with the upper beam. The cassette can be inserted from above into receivers mounted to the upper sides of the tank. An aerator grid is provided separately. The primary components of the aerator grid are flat assemblies of pipes and structural members that can be inserted vertically downwards into spaces between the cassettes. Air holes in the aerators can be located to provide bubbles both into the skirts and optionally also into the spaces between cassettes. The top beam of each cassette is attached to the tank and bears the weight of the cassette.

The module may also be described as having membranes extending upwards from a potting head. The potting head is located between two opposed walls of a skirt extending below the bottom of the potting head. There are passages for air to flow vertically through the potting head. An aerator is provided on each side of the module. Each aerator has one or more holes and creates bubbles both between the wall of the skirt and outside of the skirt. Gas flow is provided at one time only or primarily to one of the aerators and at another time only or primarily to another of the aerators. Gas flows through the potting head to produce bubbles during both periods of time, optionally continuously. An aeration method involves producing bubbles primarily or only to one side of the module, alternating from one side of the module to the other, while also producing bubbles within the module or between the membranes, optionally continuously.

One or more modules may be connected to a permeate header above the membrane surfaces of the modules. The permeate header is in communication with an isolation valve to isolate the permeate header from other pipes in the permeate withdrawal system. The permeate header is also in communication with a vent valve on the module side of the isolation valve operable to open the permeate header to atmosphere. A chemical injection pipe allows a chemical to be injected into the permeate header. To clean the modules, the isolation valve is closed. Optionally, the water (mixed liquor in the case of a membrane bioreactor) level in the tank may be reduced. A cleaning chemical is injected into the permeate header where it is mixed with water in the permeate header to a desired concentration. With the permeate header above the water level, the vent valve is opened allowing the chemical to flow through the membrane surfaces. To resume permeation, the tank is re-filled, the vent valve is closed, and the isolation valve is re-opened. A cleaning method involves flowing a chemical cleaning solution by force of gravity through a membrane module, optionally by injected a concentrated solution into a vented portion of a permeate withdrawal system located above the water level in a tank holding the module. By this method, only a small amount of chemical is used. The chemical may be evenly distributed among a number of modules without a high flow rate. The chemical remains at high concentration near the module, with little dilution into the water outside of the module.

### BRIEF DESCRIPTION OF THE DRAWINGS

FIG. 1 is a cross section of a module.

FIG. 2 is a side view of a cassette of modules in a tank, the tank shown in section.

FIG. 3 is a side view of an aerator assembly.

FIG. 4 is a schematic top view of a tank with cassettes and aerator assemblies installed.

FIG. 5 shows a partial end view of cassettes in a tank with the lower parts of a set of modules as in FIG. 1 in cross section and a schematic aeration system at one period of time.

FIG. 6 shows a partial end view of cassettes in a tank with the lower parts of a set of modules as in FIG. 1 in cross section and a schematic aeration system at another period of time.

FIG. 7 is a longitudinal cross section of a part of the permeate header of FIG. 2.

FIG. 8 is a cross section cut across the diameter of a part of the permeate header of FIG. 2.

### DETAILED DESCRIPTION

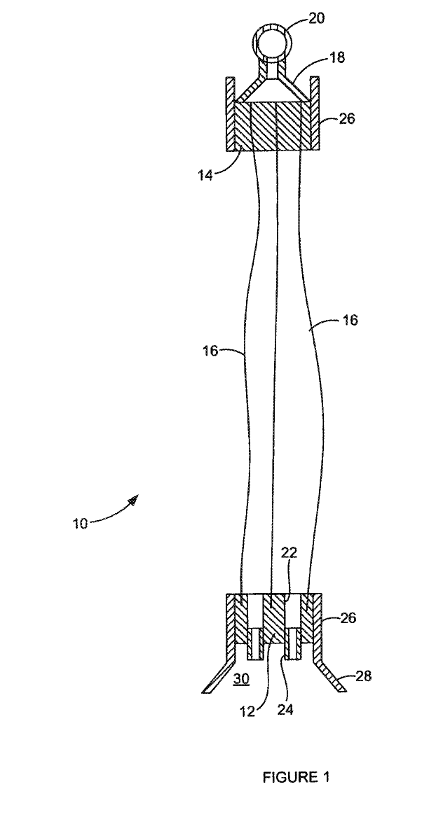

Referring to FIG. 1, a module 10 has a lower potting head 12 and an upper potting head 14. A large number of hollow fiber membranes 16 are potted in the potting heads 12, 14. The potting heads 12, 14 are also sometimes called headers or tube sheets. Only a few of the membranes 16 are shown to simplify the drawing. The membranes 16 are plugged at their lower ends in a block of potting resin within the lower potting head 12. The membranes 16 pass through the upper potting head 14 so as to be open to a permeate collector cap 18 sealed to the upper surface of the upper potting head 14. The cap 18 is connected to a permeate header 20 which is in turn connected to a source of suction operable to withdraw permeate through the membranes 16. The potting heads 12, 14 may be attached to a frame 26 (only part shown) to space the potting heads 12, 14 and allow the module 10 to be lowered into a tank of liquid to be filtered. The module 10 is intended to be immersed with the membranes 16 oriented vertically in an open tank.

In plan view, the module 10 may be, for example, round or square with a diameter or width of between 100-200 mm or 100-150 mm. Several modules 10 may be arranged side by side to create a rectangular assembly. The height of the module 10 may be 1-2 m. The total membrane surface area may be 15-25 square meters. The lower potting head 12 has one or more, for example 1-10, holes 22 passing through it between the membranes 16. Each hole 22 may be 5-10 mm in diameter. One or more of side walls of the lower potting head 12, parts of a frame 26 holding the module 10, and skirt walls 28, extend downwards at the sides of the lower potting head 12 to define the sides of an open bottom chamber 30 (sometimes called a skirt) below the lower potting head 12. The lower potting head 12 or parts of a frame 26 holding the module 10 may define the top of the chamber 30 or additional top plates may be used. Extension tubes 24 may protrude from the holes 28 into the chamber 30. If several modules 10 are placed side by side to form a rectangular assembly, a skirt wall 28 may extend along the length of the entire assembly to form one long chamber 30 below several modules 10. Alternately, additional dividing walls may be placed between each pair of modules 10 to provide a separate chamber 30 below each module 10.

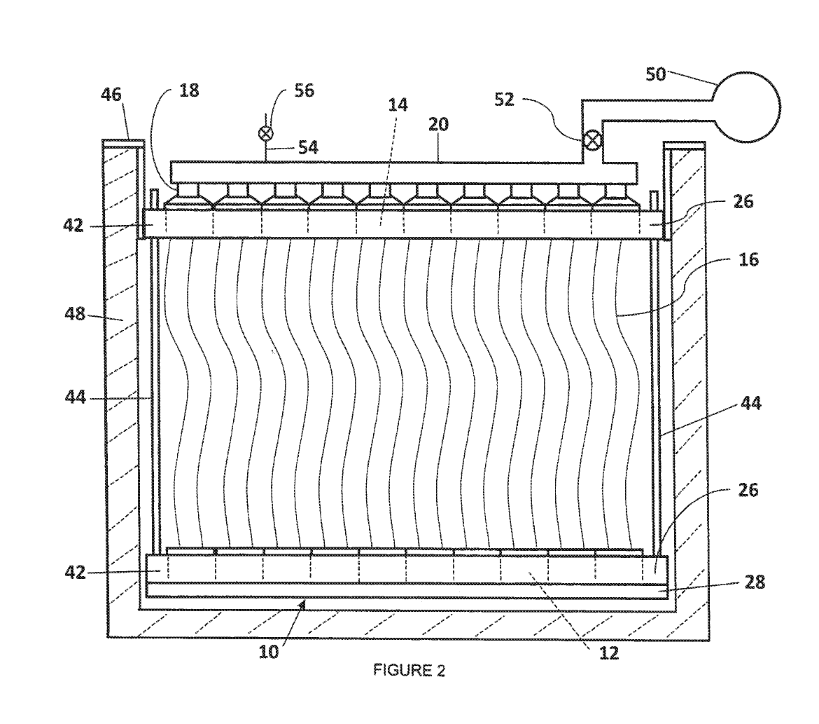

Referring to FIG. 2, a set of modules 10 are held by their potting heads 12, 14 in a common frame 26 to form a cassette 60. The modules 10 are placed as close together as possible in a row. The frame 26 comprises horizontal beams 42 and vertical posts 44. The permeate collection header 20 runs parallel to the frame 26 and is connected to the cap 18 of each module 10. The permeate collection header 20 is also communicates with one or more larger permeate collection pipes 50 through one or more isolation valves 52. In the example shown, one end of the permeate header 20 is capped and the other end of the permeate header 20 is attached to a shared permeate collection pipe 50 through an isolation valve 52 associated with only one permeate collection header 20. The isolation valve 52 allows isolation of one or more beam-cassettes for maintenance without interruption of operation. The permeate collection pipe 50 runs along the side of the tank 48 at a right angle to the permeate header 20 and is connected to the permeate headers of other sets of modules located in the tank 48 beside the set of modules 10 shown. The permeate collection pipe 50 is also attached to a source of suction (not shown) operable to withdraw permeate from the modules 10. The upper one of the beams 42 is normally immersed in water in the tank 48 while the permeate header 20 may be normally above or within the water.

Each cassette 60 is held in a pair of guides 46 connected to the tank 48. The guides 46 of a pair face each other on opposite sides of the tank 48. The cassette 60 slides vertically downwards into the guides 46. An upper beam 42 of the cassette 60 bears on abutments of the guides 46 such that the weight (or buoyancy) of the cassette 60 as a whole is resisted via the upper beam 42. The guides 46 may optionally restrain the lower beam 42 laterally or have no contact with the lower beam 42. The distance between the top and bottom beams 42 is set by adjusting connections between the vertical posts 44 and the beams 42. The upper beam 42 spans the width of the immersion tank 48 and is attached to the walls of the tank 48 on both sides via the guides. While the upper beam 42 (and the upper potting heads attached to it) is normally immersed, the attachment points to the guides 46 or between the guides 46 and the tank 48 can be above the water surface.

The vertical posts 44 are rigid structural pieces (pipe or beam) that connect the top and bottom beams 42 and maintain them at a fixed and adjustable distance. There are two vertical posts 44 per cassette 60, one at each end of the cassette 60. The distance between the top and bottom beams 42 should be slightly less than the length of the fibers between the potting heads 12, 14 to provide some hollow fibre slack. The amount of fiber slack can be adjusted for performance. Vertical posts 44 may be fixed into the bottom beam 42 (rotation allowed) but have an adjustable slide-type connection in the top beam 42 to make adjustments to the spacing of the beams 42. The vertical posts 44 and guides 46 maintain the bottom beam 42 in a fixed vertical position during operation when the bottom beam 42 becomes buoyant.

The vertical posts 44 can be used while the cassette 60 is in the tank 48 to change the position of the bottom beam 42 in order to adjust slack and ensure even air flow rate through the holes in the lower potting head. First, the top beam 42 is roughly levelled by adjusting the attachment points to the tank 48 or guide 46. Second, the bottom beam 42 is pushed down until hollow fibres 16 are taut. The vertical posts 44 are then moved back up by a distance that will provide the desired fibre slack. Third, the air flow is turned on at low value and the bubble pattern at the surface is observed. The vertical posts can then be moved up and down until air flow is even, making sure that the required adjustment is split evenly between the two vertical posts 44 (one is moved up, the other is moved down) to avoid changing slack significantly. The vertical posts 44 are then locked in place.

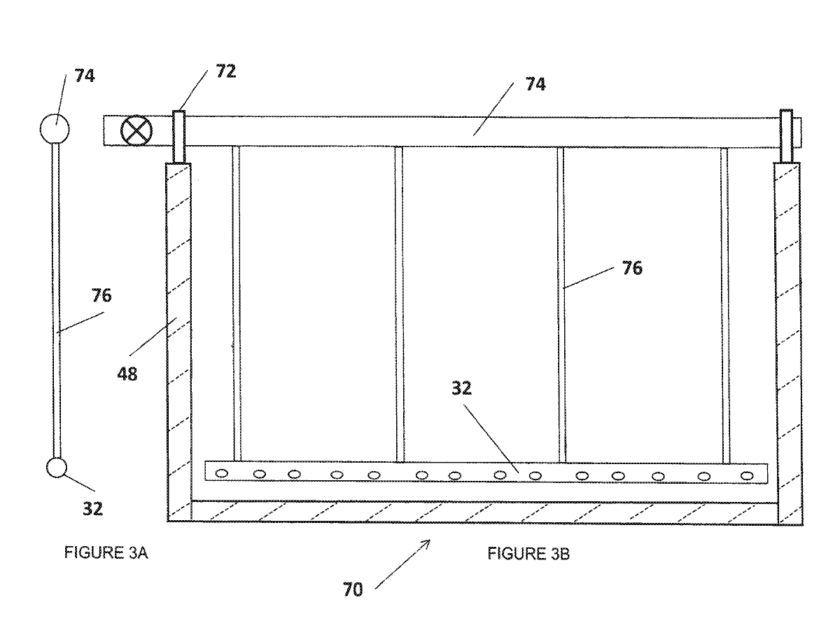

FIG. 3 shows a side view of an aerator assembly 70. The aerator assembly 70 is separate from the cassettes 60. An aerator assembly 70 is inserted between pairs of cassettes 60 and optionally beside outer cassettes. Each aerator assembly 70 slides vertically into an aerator guide 72 attached to the tank 48 walls. The aerator guide 72 may extend downwards into the tank 48 (rather than upwards as shown) like the guides 46 for the cassettes 60. Each aerator assembly 70 consists of an aerator header 74, an aerator 32 and a number of down-pipes 76. The aerator assembly 70 is generally planar. Aerators 32 are also sometimes called air, gas or bubble spargers, or simply spargers.

An aerator header 74 runs between each pair of cassettes 60. A down-pipe 76 is connected to the aerator header 74 on each side of it. Optionally, additional down-pipes 76 may be provided every 200-500 mm. The down pipes 76 may be long enough to position the aerators 32 below the skirts of the cassettes 60 when installed. The aerator assembly 70 described herein primarily occupies spaces in a tank 48 that would be required in any event for gaps for water flow between cassettes 60 and thereby facilitates a high tank intensity (square meters of membrane surface area per unit volume or surface area of a tank).

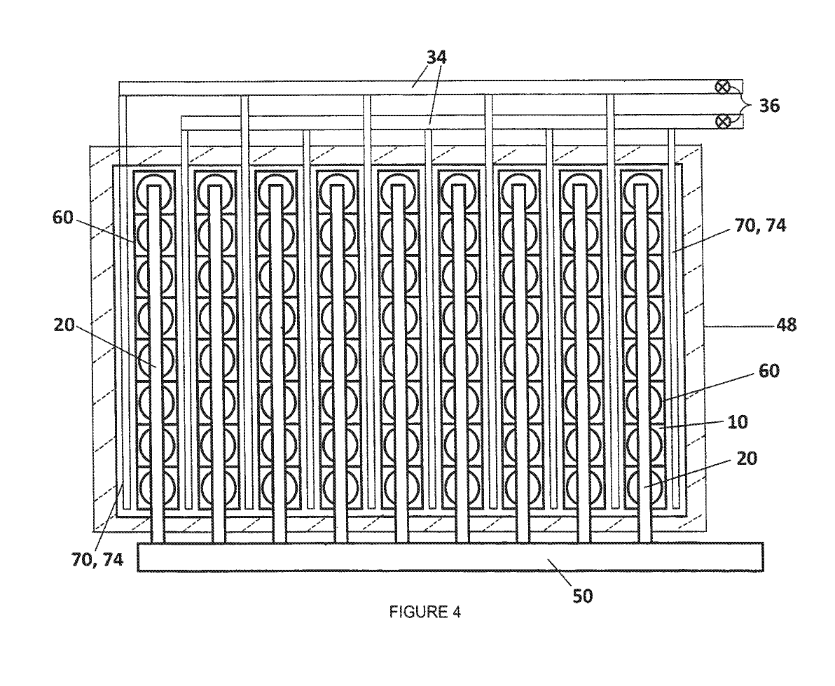

Referring to FIG. 4, the tank 48 is typically rectangular in plan view. Cassettes 60 are laid across the tank width or length. A useful feature of the beam-cassette structure described herein is that the length of the cassettes 60 may be made in increments of the width or diameter of the modules 10 such that the length of a cassette may be generally equal to, through slightly less than, the width or length of the tank 48. For retrofitting cases, custom-length cassettes can be built using a standardized size of module 10 merely by changing the length of the beams 28. Cassettes 60 and aerator assemblies 70 may be placed side by side across the remaining dimension of the tank 48 to efficiently fill the tank area to a high tank intensity. The permeate headers 20 are connected to a main permeate header 50 on one side of the tank 48. The aeration assemblies 70 are connected in an alternating pattern to two separate aeration headers 34 on the other side of the tank 48, or to a single header if, optionally, air will be supplied to all cassettes 60 in the tank 48 at the same time.

The tank 48 may be 2-3 m deep. In a membrane bioreactor application, the tank 48 also contains a layer of mixed liquor distribution pipes at the bottom (not shown) and a return activated sludge outlet or overflow (not shown). It is desirable that the membrane tank 48 be completely filled with cassettes 60 to ensure a uniform flow pattern in the tank 48.

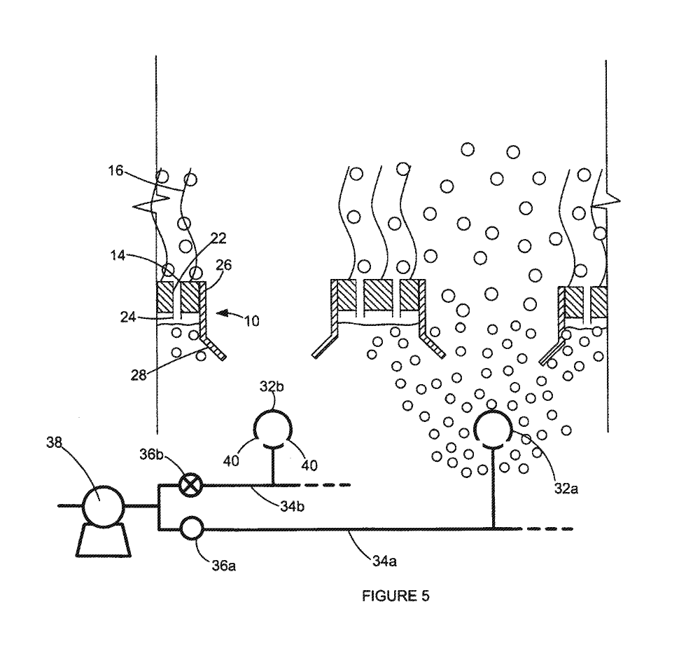

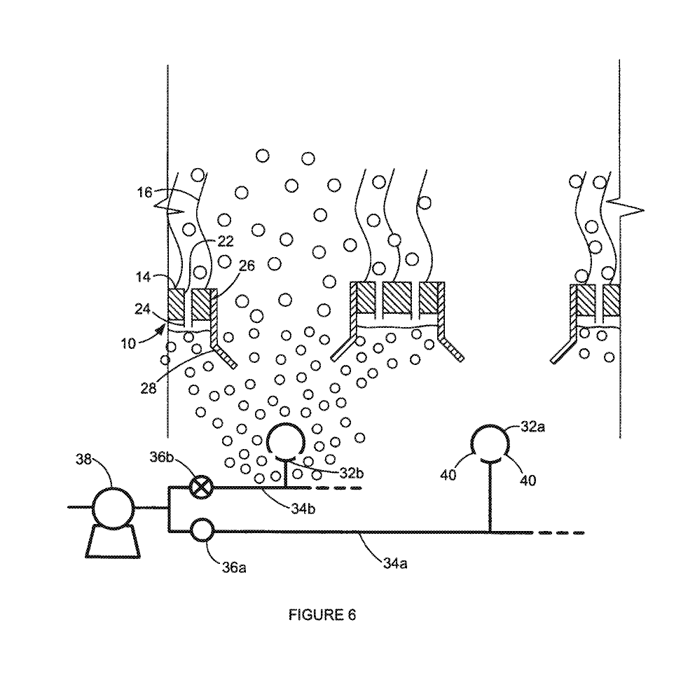

Referring to FIGS. 5 and 6, a number of modules 10 may be immersed side by side in a tank (not shown in FIGS. 5 and 6) of water to be filtered, for example re-circulated mixed liquor in a wastewater treatment plant. Each module 10 shown in FIGS. 5 and 6 may be part of a cassettes 60 extending in length perpendicular to the page. A group of modules 10 are spaced apart, for example at 200-500 mm center to center, to provide gaps between them. An aerator 32 is located between each spaced pair of modules 10, and optionally beside but outside of the modules 10 at the edges of the group of modules 10. The aerators 32 may be pipes located 100-500 mm below the lower potting heads 12 with 5-15 mm air holes 40 every 50-100 mm on each side of the aerator 32. The air holes 40 may be oriented radially pointing 30-60 degrees below horizontal. The aerators 32 are attached to headers 34 connected through valves 36 to an air blower 38 or another source of a pressurized gas that will be used to make gas bubbles. A process of membrane aeration is also sometimes called air, gas or bubble sparging, or simply bubbling.

When air, or another gas, flows to an aerator 32, bubbles are created at the air holes 40. A fraction of the bubble gas flow, for example between 25% and 75%, is captured in the chambers 30 of the modules 10, forms a pocket of gas below the lower potting heads 12, and flows through the holes 22 in the lower potting heads 12 to create bubbles within the module 10. The remainder of the bubbled gas flow rises through the gaps between the modules 10. Bubbles rising in a gap entrains water in the tank causing water to also rise through the gap. The fraction of the bubble gas flow captured in the chambers 30 may be varied by the varying the design, position or location of the aerators 32, by varying the width of the gaps between the modules 10, or by varying the width of the bottom of the skirt walls 28. The aerators 32 and lower potting heads 12 within a cassette 60 are preferably leveled to promote an even distribution of air flow from the air holes 40 of an aerator or from the holes 22 of the one or more lower potting heads 12 of a cassette 60.

The aerators 32 may be connected to the headers 34 such that each header 34 feeds gas to every second aerator 32. For example, if the aerators 32 in a tank are numbered from left to right, the even numbered aerators 32 are attached to a first header 34a and the odd numbered aerators 32 are attached to a second header 34b. The flow of gas from the blower 38 may be switched from first header 34a to second header 34b by closing valve 36a while opening valve 36b. The flow of gas may be switched back to the first header 34a after a period of time by opening valve 36a while closing valve 36b. The gas flow may be switched back and forth repeatedly while permeation and backwash or relaxation cycles of the filtration operation are on going. FIG. 6 shows the gas flow with valve 36a closed and valve 36b open while FIG. 5 shows the gas flow with valve 36a open and valve 36b closed.

By the method described above, bubbles are provided in the gaps beside a module 10 first on one side of a module 10 and then on the other side of the module 10. This promotes horizontal water flow through the membranes 16. However, since there are always bubbles coming into one side of the chamber 30, the rate of gas flow of bubbles produced within the module 10 through the holes 22 is substantially constant. In this way, it is difficult for foulants in the water to settle within the module 10. In particular, the method inhibits solids accumulation in the module 10 near the lower potting head 12. Avoiding fouling just above the lower potting head 12 is important because it is an area that is often prone to fouling in vertical hollow fiber membranes and a difficult area to clean. Dead end potting of the membranes 16 in the lower potting head, though optional, is also helps inhibit fouling near the lower potting head 12 since transmembrane pressure decreases with distance from a permeating header due to head losses to permeate flow in the lumens in the membranes 16.

Optionally, extension pipes 24 may be inserted into the bottom ends of the holes 22. The extension pipes 24 protrude into the chamber 30, for example by 10-30 mm. A gas pocket forms in the top of the chamber 30 that is always at least as thick as the length of protrusion of the extension pipes 24. The gas pocket is usually thicker than that, with air overflowing into the extension pipes 25 and through the holes 22. The additional gas pocket thickness provided by the extension pipes 24 allows gas to distribute across the chamber 30 more quickly as gas flow is switched from one aerator 32 to another and so promotes a more nearly even gas flow among holes 22 spaced across the width of a module 10.

During a maintenance cleaning operation, the cleaning solution is preferably distributed evenly to all modules. The concentration of cleaning solution should be high (though within the limit of the membrane material tolerance) and excess dilution into water in the tank outside of the modules is preferably avoided. The cleaning solution is preferably delivered to the membrane surface and allowed to react there with minimal negative impact on biomass in the membrane tank. Maintenance cleaning is preferably performed in a full or nearly full tank. Maintenance cleaning can be done in an empty tank to avoid dilution into the water in the tank, but in that case most of the solution is lost by permeation near the bottom of the hollow fibres where the static pressure of a cleaning solution inside the module is highest. In the filtration system described herein, fouling near the bottom of the membranes is reduced both by the aeration method and dead end potting of the bottom of the fibres. In this case, it is desirable to encourage the chemical solution to permeate to the extent possible through the upper ends of the membranes whereas maintenance cleaning into an empty tank may cause a further loss of cleaning solution at the bottom of the membranes due to the relative lack of fouling near the bottoms of the membranes.

The permeate pumping system is often used to deliver maintenance cleaning solution to membrane modules. However, a large amount of chlorine solution is needed just to fill the permeate piping network even before any cleaning solution is contacted with the membrane. Further, a large flow rate is needed to deliver the cleaning solution evenly to all modules to make use of the equalizing effect of pressure loss in the modules. The combined impact of these constraints is that a large amount of low concentration chlorine solution permeates the membrane, dilution is excessive and a significant part of the biomass in the tank may be killed.

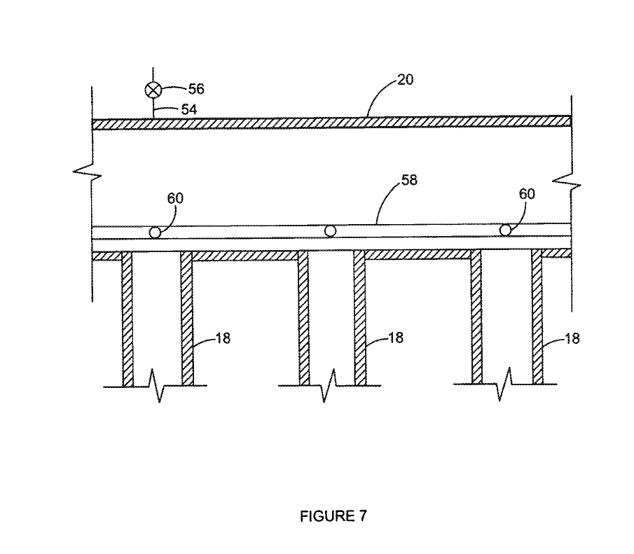

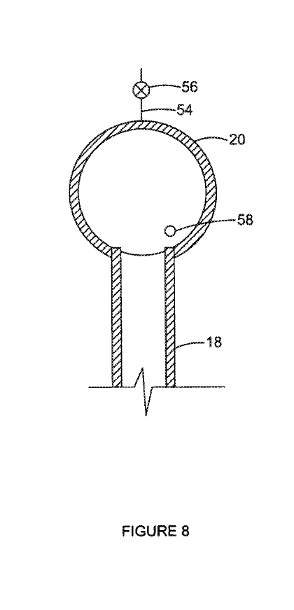

Referring to FIGS. 2, 7 and 8, the permeate header 20 is connected to a vent pipe 54 with a vent valve 56. Opening the vent valve 56 exposes the inside of the permeate header 20 to atmospheric pressure. A chemical injection tube 58 has a section running inside of the permeate header 20 with small injection holes 60 spaced along its length. Another section of the chemical injection tube 58 is located outside of the permeate header 20 and connected, typically through intermediate pipes and valves not shown, to a chemical pump 62 connected to a chemical tank 64.

To perform a maintenance cleaning, the permeate header 20 is isolated from the permeate pumping network by closing isolation valve 52. Alternatively, an isolation valve could be provided and closed further downstream in the permeate network so that multiple sets of modules 10 connected to permeate pipe 50, for example all of the modules 10 in a tank 48, can be maintenance cleaned at the same time. Closing the isolation valve 52 isolates a known volume of permeate in communication with one or more permeate headers 20.

An amount of concentrated chlorine or other cleaning chemical, the amount optionally pre-determined based on the known volume mentioned above and a desired final chemical cleaner concentration, is injected in the permeate header 20 via the chemical injection tube 58. The chemical cleaner flows out of the injection holes 60 and rapidly mixes into permeate in the permeate header 20 to the desired final concentration. The chemical solution remains in the permeate header 20 at this stage although a small amount of permeate is displace into the membrane tank 48. Membrane aeration is preferably turned off to minimize dispersion of the cleaning solution in the following steps.

The mixed liquor level in the tank 48 is optionally partially lowered to create or increase a potential driving force in a direction opposite to normal permeation. This reverse-permeation driving force may be around one or more 10 s of cm, but preferably less than 50 cm. Sufficient potential reverse-permeation driving force may already be available without lowering the mixed liquor level if the permeate header 20 is located sufficiently far above the normal water level in the tank 48. In general, the permeate header 20 should at least be completely above the water level before a flow of chemical solution from the permeate header is initiated. Optionally, since fouling often occurs in the first 10 or 20 cm below the upper header of a vertical module, the water level may be lower to 10 or 20 cm below the bottom of the upper header to encourage flow of cleaning chemical through the upper parts of the membranes. The water level can be lowered by partially draining the tank 48 any time before opening the vent valve 56. Optionally, the water level can be lowered by shutting of flow of water into the tank while continuing to withdraw permeate before closing isolation valve 52.

Chemical flow is initiated by opening vent valve 56 to connect the interior of the permeate header 20 to atmosphere. This allows the contents of the permeate header 20 to reverse-permeate by gravity. The vent valve 56, or the extent to which it is opened, can be chosen so that the reverse-permeation (chemical discharge) time of the cleaning solution provides the desired contact time for the cleaning chemical. Optionally a wait time of up to about 5 minutes may be provided after the reverse-permeation is substantially completed to allow time for the chemical cleaner to further react with foulants.

When the cleaning solution has substantially all reverse-permeated, and any wait time has elapsed, the level in the tank 48 is increased to its normal set point and the permeate header 20 fills with water by forward-permeation while some air is evacuated through vent valve 56. Vent valve 56 is preferably located at a high point of the isolated area in or in communication with the isolated permeate header 20. Vent valve 56 can then be closed, membrane bubbles scouring resumed, and isolation valve 52 opened to put the modules 10 back into operation. Any air still trapped in the permeate header 20 may be removed through the ordinary air collector of the permeate system. The invention protected by this document is defined by the following claims. The claims are not limited to the specific examples of apparatus or process described herein.

I claim:

1. An immersed membrane apparatus comprising,
a) a plurality of cassettes each having a line of membrane modules, each membrane module having an upper permeating header and a lower header with integral gas holes, the cassettes arranged in a spaced side by side arrangement in a tank;
b) open bottomed chambers in communication with the gas holes in the lower headers of the modules; and,
c) a plurality of generally planar aerator assemblies located in the spaces between the cassettes, the aerator assemblies comprising aerators having holes to discharge bubbles located to provide bubbles into the skirts.

2. The apparatus of claim 1 wherein the plurality of aerator comprises,
a) a first aerator configured and located so as to simultaneously provide bubbles within the skirt and outside of the skirt on one side of a module;
b) a second aerator configured and located so as to simultaneously provide bubbles within the skirt and outside of the skirt on the other side of the module; and,
c) an aeration system to provide a flow of gas at different times to the first aerator and the second aerator.

3. The apparatus of claim 1 or 2 wherein each cassette comprises a cassette frame comprising upper and lower beams holding the upper and lower headers of the membrane modules in the cassette and side members located on opposed sides of the cassette frame spacing the upper and lower beams apart wherein the distance between the upper and lower beams at each side member is separately adjustable.

4. The apparatus of any of claims 1 to 3 wherein the holes of the aerators are located to also provide bubbles into the spaces between the cassettes.

5. An immersed membrane apparatus comprising,
a) a plurality of cassettes each having a single line of membrane modules, each membrane module having an upper permeating header and a lower header with integral gas holes; and,
b) open bottomed chambers in communication with the gas holes in the lower headers of the modules,
wherein
c) each cassette comprises a cassette frame comprising upper and lower beams holding the upper and lower headers of the membrane modules in the cassette and side members located on opposed sides of the cassette frame spacing the upper and lower beams apart wherein the distance between the upper and lower beams at each side member is separately adjustable; and,
d) the cassettes are mounted in a tanks with the weight of the cassettes supported by connections between the top beam and the tank.

6. The apparatus of any of claims 1 to 5 comprising,
e) a permeate header above the membranes area of at least one membrane module in communication with the permeating header of the module;
f) an isolation valve in communication with the permeate header;
g) a vent valve in communication with the permeate on a module side of the isolation valve; and,
h) a chemical injection pipe having one end in communication with the inside of the permeate header on the module side of the isolation valve and another end in communication with a chemical pump and a supply of a cleaning chemical.

7. A membrane filtration system comprising,
a) a membrane module having a membrane filtering area;
b) a permeate header above the membrane filtering area;
c) an isolation valve between the permeate header and a further permeate collection conduit;
d) a vent valve in communication with the permeate header on a module side of the isolation valve; and,
e) a chemical injection pipe having one end in communication with the inside of the permeate header on the module side of the isolation valve and another end in communication with a chemical pump and a supply of a cleaning chemical.

8. A process for aerating an immersed suction driven module of generally vertical hollow fiber membranes, the module having two opposed sides, comprising the steps of,
a) providing bubbles in a first period of time within the module and at one side of the module;
b) after step a), providing bubbles in a second period of time within the module and at the other side of the module; and,
c) repeating steps a) and b).

9. The process of claim 8 wherein the first period of time and the second period of time are substantially sequential such that bubbles are provided from within the module substantially constantly during steps a) and b).

10. The process of claim 8 or 9 wherein bubbles are provided within the module via holes through a potting head in which the bottoms of the membranes are potted.

11. The process of any of claims 8 to 10 wherein the bubbles in step a) are provided by a single aerator and the bubbles in step b) are provided from a different single aerator.

12. An process for inhibiting fouling of a membrane module comprising producing bubbles primarily or only to one side of the module, alternating from one side of the module to the other, while also producing bubbles within the module or between the membranes.

13. The process of claim 12 wherein bubbles are produced within the module or between the membranes generally continuously.

14. A process for cleaning an immersed membrane module in a tank comprising the steps of,
a) isolating a volume of permeate in communication with and above the module;
b) locating the surface of water in the tank at a level below the isolated volume of permeate;
c) injecting a cleaning chemical into the isolated volume of permeate; and,
d) venting the isolated volume of permeate to atmosphere.

15. A membrane cleaning method comprising flowing a chemical cleaning solution by force of gravity through a membrane module, optionally by injected a concentrated solution into a vented portion of a permeate withdrawal system located above the water level in a tank holding the module.
